(19) United States
(12) Patent Application Publication
(10) Pub. No.: US 2012/0256455 A1
(43) Pub. Date: Oct. 11, 2012

(54) PASSENGER SEAT WITH WIRE-FRAME SUPPORT

(76) Inventors: Raul Daniel Flores Aguirre, Chihuahua (MX); Jesus Eduardo Rosales Salazar, Chihuahua (MX)

(21) Appl. No.: 13/293,496

(22) Filed: Nov. 10, 2011

Related U.S. Application Data
(60) Provisional application No. 61/456,638, filed on Nov. 10, 2010.

(51) Int. Cl. B60N 2/66; B23P 11/00; B60N 2/01; B60N 2/68; B60N 2/58

(52) U.S. Cl. 297/232; 297/452.18; 29/428

(57) ABSTRACT

Described are passenger seats comprising a seat body; at least one wire-frame support comprising a base coupled to the seat body and at least one wire-frame member pivotally coupled to the base; and at least one seat cover coupled to the seat body, wherein the at least one wire-frame support is at least partially enclosed between the at least one seat cover and the seat body. The at least one seat cover may be formed of an elastic fiber or plastic. The at least one wire-frame support may be positioned on the seat body in a location configured to provide support for a passenger's neck or lumbar area. Also described are passenger seats comprising a seat body; at least one wire-frame sub-assembly; and at least one seat cover coupled to the seat body, wherein the at least one wire-frame sub-assembly is at least partially enclosed between the at least one seat cover and the seat body.

### CROSS REFERENCE TO RELATED APPLICATIONS

This application is related to and claims priority benefits from U.S. Provisional Application Ser. No. 61/456,638, filed on Nov. 10, 2010, entitled “Concept Seat.” The '638 application is hereby incorporated in its entirety by this reference.

### FIELD OF THE INVENTION

The field of the invention relates to passenger seats. More specifically, it relates to passenger seats with enhanced neck and/or lumbar support for the passenger.

### BACKGROUND

In various modes of transportation, a passenger may be subjected to a passenger seat for various lengths of time. In airline travel, for example, it is not uncommon for a passenger to be subjected to a passenger seat for multiple hours. During such time, it is beneficial to the passenger's overall health if the passenger's neck is properly supported. It is also beneficial if the passenger's lumbar area is properly supported. Either or both supports may also increase a passenger's overall comfort level.

Traditional passenger seats, with fixed orientation positions, cannot be adequately adjusted to provide each unique passenger with the unique neck or lumbar support, or comfort level, that he or she requires. Moreover, known adjustable passenger seats often require extreme mechanical manipulation of the passenger seat in a way that deforms a portion of the entire passenger seat so that it enters the personal space allotted to other passengers. This resulting deformation typically impacts other passengers in close proximity to the passenger seat by disrupting the space otherwise available to them, for example. The adjustability of these seats is also typically limited.

With the advent of deformable elastic fabrics and plastics, it may be desirable to provide passenger seats with easily adjustable systems to support each unique passenger's neck and/or lumbar area, while providing minimal deformation to the passenger seat.

### SUMMARY

Certain embodiments of the present invention include a seat body; at least one wire-frame support comprising a base coupled to the seat body and at least one wire-frame member pivotally coupled to the base; and at least one seat cover coupled to the seat body, wherein the at least one wire-frame support is at least partially enclosed between the at least one seat cover and the seat body.

In some embodiments, the at least one seat cover may be formed of an elastic fiber or plastic.

In other embodiments, the at least one wire-frame support may be positioned on the seat body in a location configured to provide support for a passenger's neck or lumbar area.

Certain other embodiments of the present invention include a seat body; at least one wire-frame sub-assembly; and at least one seat cover coupled to the seat body, wherein the at least one wire-frame sub-assembly is at least partially enclosed between the at least one seat cover and the seat body.

### BRIEF DESCRIPTION OF THE DRAWINGS

FIG. 1 is a perspective view of a passenger seat according to certain embodiments of the present invention.

FIG. 2 is a close-up perspective view of the passenger seat of FIG. 1.

FIG. 3 is a top view of a passenger seat according to other embodiments of the present invention, wherein a portion of the seat cover has been removed and the wire-frame support system is in a stowed position.

FIG. 4 is a top view of the passenger seat of FIG. 4, wherein a portion of the seat cover has been removed and the wire-frame support system is in an engaged position.

FIG. 5 is a front view of a passenger seat assembly according to other embodiments of the present invention.

FIG. 6 is a perspective view of a passenger seat according to other certain embodiments of the present invention, wherein a portion of the seat cover has been removed.

### DETAILED DESCRIPTION

Embodiments of the invention provide passenger seats with adjustable support structures for one or more physical areas of the passenger's body. While the passenger seats are generally discussed for use with aircrafts, they are by no means so limited. Rather, embodiments of the passenger seats may be used in connection with any mode of transportation or otherwise as desired.

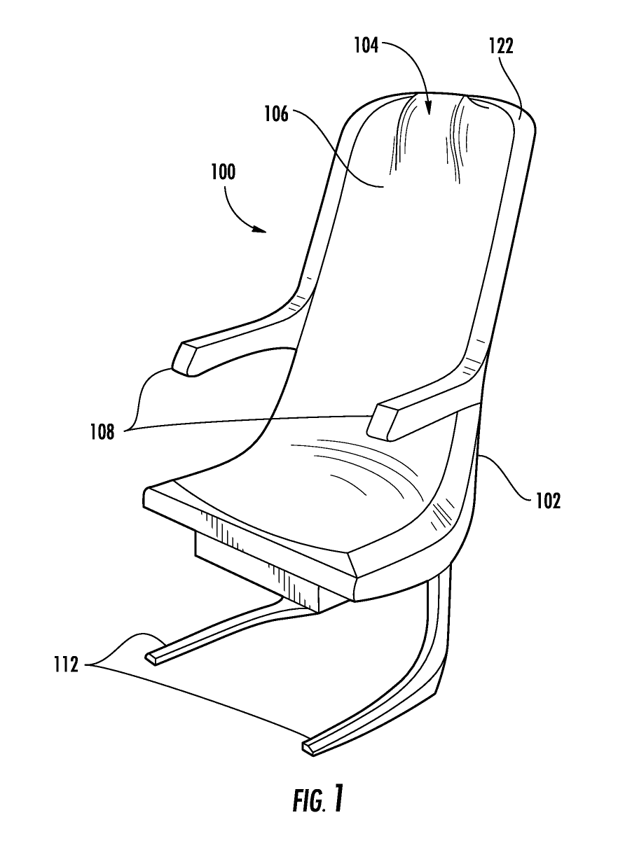

FIGS. 1-5 illustrate embodiments of a passenger seat 100. In these embodiments, the passenger seat 100 may comprise a seat body 102, at least one wire-frame support 104, and at least one seat cover 106. The passenger seat 100 may also comprise seat accessories, including but not limited to at least one cushion 107, at least one armrest 108, at least one seat-belt 110, and at least one leg 112. The passenger seat 100 may also exist within a passenger seat assembly 114 of one or more passenger seats 100. The passenger seat assembly 114 may also comprise seat accessories, including but not limited to the cushion 107, the armrest 108, the seat-belt 110, and the leg 112.

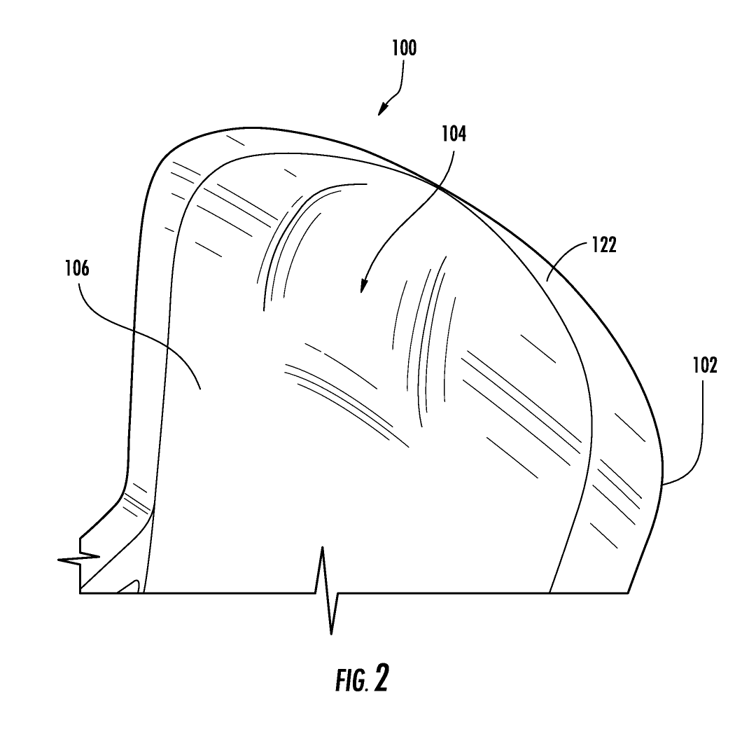

The seat body 102 provides the basic foundation, form, and shape for the passenger seat 100. The seat body 102 may have any suitable seat-like shape, such as the embodiments illustrated in FIG. 1. Throughout embodiments, the dimensions of the seat body 102 may vary as needed, depending on the desired compactness and comfort levels. In some embodiments, the profile of the seat body 102 may be L-shaped. In some embodiments, such as the embodiments illustrated in FIGS. 1-2, the profile of the seat body 102 may be curvilinear. The seat body 102 may be formed from a variety of materials, including but not limited to aluminum, steel, other metallic materials, composite materials, plastics, or other similar materials. In some embodiments, the seat body 102 may also comprise traditional seat accessories, including but not limited to the cushion 107, the armrest 108, the seat-belt 110, and the leg 112.

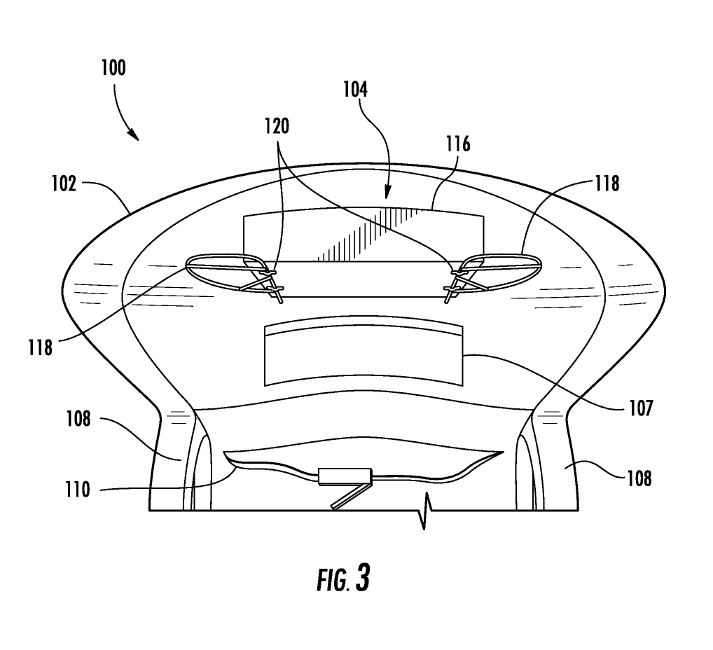

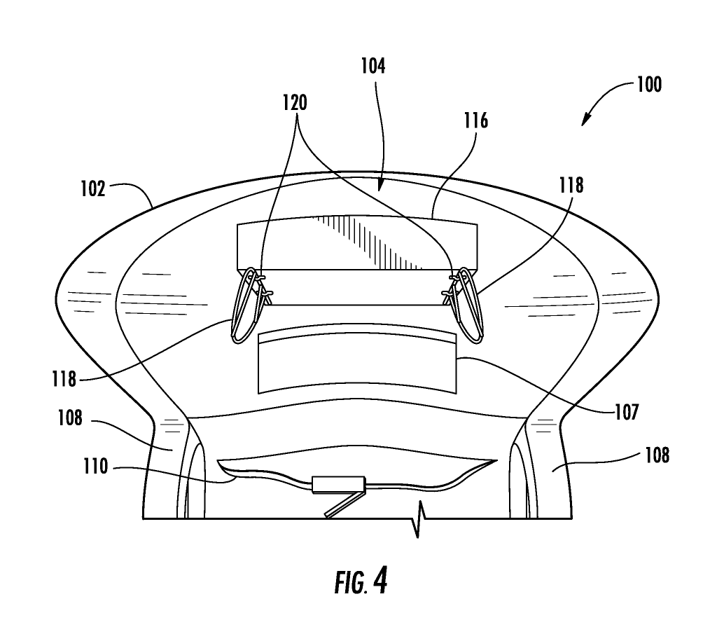

The wire-frame support 104 is capable of providing unique support to the passenger while he or she utilizes the passenger seat 100. The wire-frame support 104 may be comprised of a base 116 and at least one wire-frame member 118. In some embodiments, as illustrated in FIGS. 3-4, the wire-frame support 104 may be comprised of two or more wire-frame members 118.

The base 116 of the wire-frame support 104 may be coupled to the seat body 102 and may serve as a foundation for the wire-frame member 118. In some embodiments, the base 116 may be coupled to the seat body 102 by a variety of mechanisms, including but not limited to an adhesive, bolts, fasteners, screws, and other coupling mechanisms. In other embodiments, the base 116 and the seat body 102 may be integrally formed. The base 116 may have any suitable cross-sectional shape including but not limited to circular, rectilinear, trapezoidal, or other similar polygonal shape. In other embodiments, it may be suitable for the length and width of the cross-sectional shape of the base 116 to have differing dimensions. The depth of the base 116 may also vary throughout embodiments. In some embodiments, for example, the depth of the base 116 is such that the base 116 does not contact the seat cover 106 when the seat cover 106 is coupled to the seat body 102. The base 116 may be formed from a variety of materials, including but not limited to aluminum, steel, other metallic materials, wire, composite materials, plastics, foam, or other similar materials.

The wire-frame member 118 is pivotally coupled to the base 116. In some embodiments, the wire-frame member 118 may be coupled to the base 116 by a variety of mechanisms, including but not limited to hinges, fasteners, and other pivotally coupling mechanisms. In some embodiments, the wire-frame member 118 may be pivotally coupled to the base 116 via a friction hinge, which relies on a constant friction force within the hinge to hold a position until torque that exceeds the passive weight of a passenger is applied to overcome the hinge resistance torque and move the wire-frame member 118 to another position within its range of motion. As a result, the wire-frame member 118 may only be adjusted by direct, intentional force or manipulation by the passenger (i.e., the passenger's weight when utilizing the wire-frame support 104 will not alone be able to adjust the wire-frame member 118). In some embodiments, the friction force between the wire-frame member 118 and the base 116 will likewise prevent unintentional adjustment of the wire-frame member 118. In other embodiments, the wire-frame member 118 may be secured into place after adjustment by a variety of manners, including but not limited to a locking mechanism.

In the embodiments illustrated in FIGS. 3-4, for example, the two wire-frame members 118 are pivotally coupled to the base 116 by a plurality of brackets 120. The wire-frame members 118 may pivot from the base 116 to travel from a stowed position, as illustrated in FIG. 3, to an engaged position, as illustrated in FIG. 4. The stowed position, as illustrated in FIG. 3, is only one of many possible stowed positions. A stowed position is any position in which the wire-frame member 118 is fully retracted relative to the base 116. The engaged position, as illustrated in FIG. 4, is only one of many possible engaged positions. An engaged position is any position in which the wire-frame member 118 is rotated away at least some distance from the base 116.

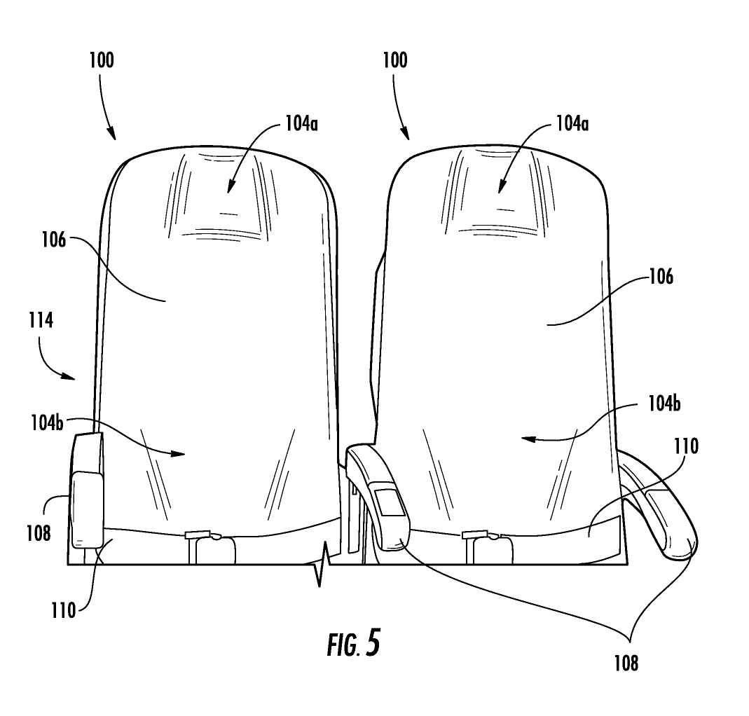

In some embodiments, the wire-frame member(s) 118 may pivot up to 90 degrees or less. In other embodiments, the wire-frame member(s) 118 may pivot beyond 90 degrees. In some embodiments, the wire-frame member(s) 118 may pivot around a latitudinal axis of the base 116. In other embodiments, the wire-frame member(s) 118 may pivot around a longitudinal axis of the base 116. In other embodiments, such as the embodiments illustrated in FIG. 5, the wire-frame member(s) 118 may pivot around a unique axis of the base 116.

The shape and position of the wire-frame member 118 may vary throughout embodiments. Moreover, in embodiments in which more than one wire-frame member 118 exist, the shape and position of each wire-frame member 118 may also vary within the embodiments. Throughout embodiments, the shape and positioning of the wire-frame member 118 is such that the wire-frame member 118 may create physical support and comfort for one or more areas of a passenger's body when the wire-frame member 118 is in an engaged position. For example, in the embodiments illustrated in FIGS. 3-4, the two wire-frame members 118 have a semi-circular shape to create support for the passenger's neck when the wire-frame members 118 are in an engaged position. Other suitable shapes for the wire-frame member 118 include but are not limited to semi-elliptical shapes, triangular shapes, and simple rod-like shapes, straight or curvilinear.

The wire-frame support 104 may be positioned at a variety of locations on the seat body 102. For example, in the embodiments illustrated in FIGS. 1-2 and 3-4, the passenger seat 100 comprises the wire-frame support 104, which is positioned toward a top of the seat body 102, so as to correspond to the position of a passenger's neck. The number of wire-frame supports 104 may also vary throughout embodiments. For example, in some embodiments, as illustrated in FIG. 5, the passenger seats 100 of the passenger seat assembly 114 each comprise two wire-frame supports 104: a neck wire-frame support system 104a is positioned toward a top of the seat body 102, so as to correspond to an estimated position of a passenger's neck, and a lumbar wire-frame support system 104b is positioned at a location below the neck wire-frame support system 104a, so as to correspond to an estimated position of a passenger's lumbar area.

The wire-frame member 118 may be formed from a variety of materials, including but not limited to wire, aluminum, iron, other metallic materials, composite materials, plastics, or other similar materials. These materials may provide the wire-frame member 118 with the strength to stay in each adjusted position, stowed or engaged, no matter the passive weight applied to the wire-frame support 104 by the passenger. In some embodiments, the wire-frame member 118 may be formed from a variety of flexible materials, which may allow the shape of at least a portion of the wire-frame member 118 to be manipulated by the passenger. Such materials may include but are not limited to wire, aluminum, other malleable metallic materials, composite materials, plastics, or other similar flexible materials. In some embodiments, such as the embodiments illustrated in FIGS. 3-4, the wire-frame member 118 may be formed of one or more wires or pieces of material, together forming the full shape from the wire-frame member 118.

The seat cover 106 is coupled the seat body 102 in a manner that captures at least a portion of the wire-frame support 104 between the seat body 102 and seat cover 106, such that the wire-frame support 104 is at least partially enclosed between the seat cover 106 and the seat body 102, such that the wire-frame support 104 is at least partially hidden from view. The seat cover 106 may cover all or only a portion of the seat body 102. The seat cover 106 may be coupled to the seat body 102 by a variety of mechanisms, including but not limited to adhesive, bolts, fasteners, screws, elastic expansion and compression (akin to a mattress pad), casing, and other coupling mechanisms. For example, in the embodiments illustrated in FIGS. 1-2, the seat cover 106 is coupled to the seat body 102 by a casing 122. The seat cover 106 may be formed from a variety of elastic or otherwise malleable materials, including but not limited to fabrics, composite materials, plastics, or other similar materials.

The use of such materials for the seat cover 106 allows the passenger to adjust the wire-frame member(s) 118 from the stowed position to one of any number of engaged positions as he or she desires such that the wire-frame member 118 is rotated some perpendicular distance away from the base 116 and against the seat cover 106, as illustrated in FIGS. 1-4. Given the characteristics of the material of the seat cover 106, the seat cover 106 will deform as a result of the contact with the wire-frame member(s) 118, as illustrated in the embodiments shown in FIGS. 1-2. The resulting position of the wire-frame member(s) 118 and seat cover 106 will provide unique support to the passenger and may be capable of further adjustment as desired. Moreover, this deformation of the seat cover 106 will only affect the passenger utilizing the passenger seat 100 (i.e., a passenger sitting behind the passenger utilizing the passenger seat 100 will not be adversely affected by such utilization). In some embodiments, the passenger may be able to modify the shape of the wire-frame member 118 for additional adjustment.

In some embodiments, the passenger may engage the wire-frame member 118 of the wire-frame support 104 by physically grasping the wire-frame member 118 through the seat cover 106 and manually pivoting the wire-frame member 118 such that it contacts the seat cover 106. In other embodiments, the wire-frame support 104 may be electronically equipped such that the passenger may engage the wire-frame member 118 through an automated control mechanism, similar to automated mechanisms common in motor vehicles that control the positioning of the motor vehicle's seat.

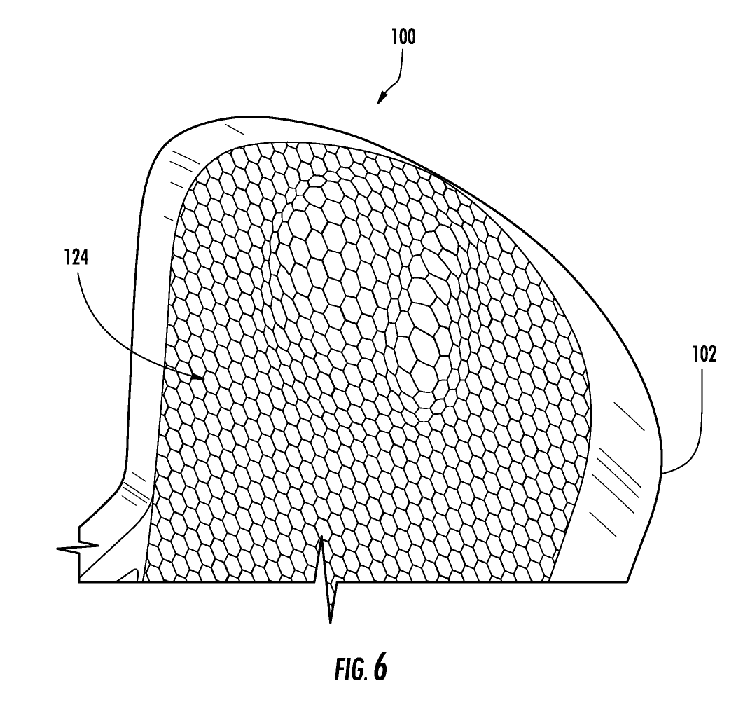

FIG. 6 illustrates other embodiments of a passenger seat 100. In these embodiments, the passenger seat 100 may comprise the seat body 102, at least one wire-frame sub-assembly 124, and the at least one seat cover 106. The passenger seat 100 may also comprise seat accessories, including but not limited to the at least one cushion 107, the at least one armrest 108, the at least one seat-belt 110, and at least one leg 112.

The wire-frame sub-assembly 124 is capable of providing unique support to the passenger while he or she utilizes the passenger seat 100. The wire-frame sub-assembly 124 may be formed from a variety of flexible or otherwise malleable materials, including but not limited to wire, aluminum, iron, other metallic materials, composite materials, plastics, or other similar materials. These materials allow for the compression and expansion of one or more portions of the wire-frame sub-assembly 124. These materials allow the passenger to manipulate and adjust the shape and/or contour of the wire-frame sub-assembly 124. These materials also may provide the wire-frame sub-assembly 124 with the strength to stay in each adjusted position no matter the passive weight applied to the wire-frame sub-assembly 124 by the passenger. The wire-frame sub-assembly 124 may be formed from one or more pieces of these materials, or a combination thereof.

The wire-frame sub-assembly 124 may have any suitable cross-sectional shape including but not limited to circular, rectilinear, trapezoidal, or other similar polygonal shape. In other embodiments, it may be suitable for the length and width of the cross-sectional shape of the wire-frame sub-assembly 124 to have differing dimensions. The wire-frame sub-assembly 124 may cover a variety of dimensional areas of the seat body 102. In some embodiments the wire-frame sub-assembly 124 may have a net- or web-like appearance. In other embodiments, such as the embodiments illustrated in FIG. 6, the wire-frame sub-assembly 124 may have a fence-like appearance, similar to common chicken wire, for example. The wire-frame sub-assembly 124 may also be positioned at a variety of locations on the seat body 102.

For example, in the embodiments illustrated in FIG. 6, one wire-frame sub-assembly 124 is positioned throughout a top area of the seat body 102, so as to correspond to possible positions of a passenger's neck. In other embodiments, the wire-frame sub-assembly 124 may be positioned at a location in relation to the seat body 102 so as to correspond to the position of a passenger's lumbar area. The number and breadth of the wire-frame sub-assemblies 124 may also vary throughout embodiments. For example, as illustrated in FIG. 6, in some embodiments, one wire-frame sub-assembly 124 may span across a width of the seat body. In other embodiments, multiple, smaller wire-frame sub-assemblies 124 may be positioned at various locations of the seat body 102.

The wire-frame sub-assembly 124 may be coupled to the seat body 102 by a variety of mechanisms, including but not limited to an adhesive, bolts, fasteners, screws, and other coupling mechanisms. The wire-frame sub-assembly 124 may be coupled to the seat body 102 at one or more points.

In these embodiments, the seat cover 106 is coupled the seat body 102 in a manner that captures at least a portion of the wire-frame sub-assembly 124 between the seat body 102 and seat cover 106, such that the wire-frame sub-assembly 124 is at least partially enclosed between the seat cover 106 and the seat body 102, such that the wire-frame sub-assembly 124 is at least partially hidden from view. Given the material of the seat cover 106, the seat cover 106 will react to the shape and contour of the wire-frame sub-assembly 124.

In use, the passenger may shape and/or adjust the shape and/or contour of the wire-frame sub-assembly 124 such that the wire-frame sub-assembly 124 creates unique physical support and comfort for one or more areas of a passenger's body. The passenger may adjust the wire-frame sub-assembly 124 by physically grasping one or more portions of the wire-frame sub-assembly 124 through the seat cover 106 and manually manipulating the shape and/or contour of the wire-frame sub-assembly 124 against the seat cover 106. In other embodiments, the wire-frame sub-assembly 124 may be electronically equipped such that the passenger may adjust the wire-frame sub-assembly 124 through an automated control mechanism, similar to automated mechanisms common in motor vehicles that control the positioning of the motor vehicle's seat.

The foregoing is provided for purposes of illustrating, explaining, and describing embodiments of the present invention. Further modifications and adaptations to these embodiments will be apparent to those skilled in the art and may be made without departing from the scope or spirit of the invention.

That which is claimed is:

1. A passenger seat comprising:
(a) a seat body;
(b) at least one wire-frame support, comprising:
(i) a base coupled to the seat body; and
(ii) at least one wire-frame member pivotally coupled to the base; and
(c) at least one seat cover coupled to the seat body;
wherein the at least one wire-frame support is at least partially enclosed between the at least one seat cover and the seat body.

2. The passenger seat of claim 1, wherein the at least one seat cover is formed of an elastic fiber or plastic.

3. The passenger seat of claim 1, wherein the at least one wire-frame support is positioned on the seat body in a location configured to provide support for a passenger's neck.

4. The passenger seat of claim 1, wherein the at least one wire-frame support is positioned on the seat body in a location configured to provide support for a passenger's lumbar area.

5. The passenger seat of claim 1, wherein the at least one wire-frame support comprises at least two wire-frame members.

6. The passenger seat of claim 1, wherein the at least one wire-frame member is formed of a flexible material.

7. The passenger seat of claim 1, wherein the at least one wire-frame member is configured to pivot around a latitudinal axis of the base.

8. The passenger seat of claim 1, wherein the at least one wire-frame member is configured to pivot around a longitudinal axis of the base.

9. The passenger seat of claim 1, wherein the at least one wire-frame member is configured to pivot from a stowed position to an engaged position.

10. The passenger seat of claim 9, wherein the at least one wire-frame member is configured to be manually pivoted from the stowed position to the engaged position.

11. The passenger seat of claim 9, wherein the at least one wire-frame member is configured to be electronically pivoted from the stowed position to the engaged position.

12. The passenger seat of claim 1, wherein the base of the at least one wire-frame support is integrally formed with the seat body.

13. The passenger seat of claim 1, wherein the at least one seat cover is coupled to the seat body via a casing.

14. A passenger seat assembly comprising a plurality of the passenger seats of claim 1.

15. A method of assembling a passenger seat, wherein the passenger seat comprises (i) a seat body; (ii) at least one wire-frame support comprising a base and at least one wire-frame member pivotally coupled to the base; and (iii) at least one seat cover, the steps comprising:
(a) coupling the base of the at least one wire-frame support to the seat body; and
(b) coupling the at least one seat cover to the seat body wherein the at least one wire-frame support is at least partially enclosed between the at least one seat cover and the seat body.

16. The method of claim 15, wherein the base of the at least one wire-frame support is coupled to the seat body in a location configured to provide support for a passenger's neck.

17. The method of claim 15, wherein the base of the at least one wire-frame support is coupled to the seat body in a location configured to provide support for a passenger's lumbar area.

18. The method of claim 15, wherein the at least one seat cover is coupled to the seat body via a casing.

19. The method of claim 15, wherein the base of the at least one wire-frame support is integrally formed with the seat body.

20. The method of claim 15, furthering comprising the step of equipping the at least one wire-frame support for automated manipulation by a passenger.
